(19) United States
(12) Patent Application Publication
(10) Pub. No.: US 2025/0047446 A1
(43) Pub. Date: Feb. 6, 2025

(54) EFFICIENT BLOCK-ACKNOWLEDGEMENT MECHANISM

(71) Applicant: Nokia Technologies Oy, Espoo (FI)

(72) Inventors: Zhijie YANG, Shanghai (CN); Mika KASSLIN, Espoo (FI); Lorenzo GALATI GIORDANO, Stuttgart (DE)

(21) Appl. No.: 18/718,251

(22) PCT Filed: Dec. 17, 2021
(86) PCT No.: PCT/CN2021/138994

§ 371 Date: Jun. 10, 2024

(51) Int. Cl. H04L 5/00

(52) U.S. Cl. CPC H04L 5/0055; H04L 5/0064

(57) ABSTRACT

A block-acknowledgement mechanism employing first and second variable-length bitmaps. The first bitmap carries a plurality of one-bit flags that enable omission, from the second bitmap, of entire segments of acknowledgement-status bits corresponding to the same acknowledgment status, e.g., received or not received. The value of a dedicated control bit in the BA-information field determines the interpretation of binary “0s” and “1s” of the second bitmap in terms of the acknowledgement status. Different embodiments are compatible with fragmented and non-fragmented transmission of the corresponding data units. At least some embodiments are beneficially capable of producing shorter BA frames than comparable prior-art solutions under at least some wireless-channel conditions.

### BACKGROUND

### Field

Various example embodiments relate to wireless communication equipment and methods and, more specifically but not exclusively, to transmission of block acknowledgements.

### Description of the Related Art

This section introduces aspects that may help facilitate a better understanding of the disclosure. Accordingly, the statements of this section are to be read in this light and are not to be understood as admissions about what is in the prior art or what is not in the prior art.

The concept of block acknowledgment (BA) was introduced in the IEEE 802.11e standard to improve quality of service (QoS). The 802.11 legacy acknowledgment mechanism provided for per-frame acknowledgements. In contrast, BA enables the recipient to notify the originator about reception of a block (e.g., uncontested burst, plurality) of data frames. As a result, the use of BA may help to beneficially reduce the overhead, improve the medium-access-control (MAC) efficiency, and/or enhance throughput.

The IEEE 802.1 lax standard retains and expands the BA mechanism. The IEEE 802.11e and 802.1 lax standards are incorporated herein by reference in their entirety.

### SUMMARY OF SOME SPECIFIC EMBODIMENTS

Disclosed herein are various embodiments of a block-acknowledgement mechanism employing first and second variable-length bitmaps. The first bitmap carries a plurality of one-bit flags that enable omission, from the second bitmap, of entire segments of acknowledgement-status bits corresponding to the same acknowledgment status, e.g., received or not received. The value of a dedicated control bit in the BA-information field determines the interpretation of binary “0s” and “1s” of the second bitmap in terms of the acknowledgement status. Different embodiments are compatible with fragmented and non-fragmented transmission of the corresponding data units. Some embodiments may be used in communication systems employing multi-link devices (MLDs). At least some embodiments are beneficially capable of producing shorter BA frames than comparable prior-art solutions under at least some wireless-channel conditions.

According to an example embodiment, provided is an apparatus, comprising a wireless transceiver and a processor connected to the wireless transceiver to generate therefor a BA frame in response to a plurality of data units externally wirelessly transmitted to the wireless transceiver, the BA frame including a BA information field; wherein the BA information field comprises: a first bitmap having a sequence of one-bit flags, each one of the one-bit flags corresponding to a respective one of non-overlapping sections of sequence numbers of the plurality of data units; and a second bitmap having encoded therein an acknowledgement status (e.g., received or not received) of each one of the plurality of data units; wherein, for each of the one-bit flags having a first binary value, the second bitmap has a corresponding segment of bits representing acknowledgement statuses of the data units of the respective one of the sections; and wherein, for each one of the one-bit flags having a second binary value, the second bitmap does not have a corresponding segment of bits.

According to another example embodiment, provided is an apparatus, comprising a wireless transceiver and a processor connected to the wireless transceiver to determine acknowledgement statuses of a transmitted plurality of data units based on a received BA frame, which includes a BA information field; wherein the BA information field comprises: a first bitmap having a sequence of one-bit flags, each one of the one-bit flags corresponding to a respective one of non-overlapping sections of sequence numbers of the plurality of data units; and a second bitmap having encoded therein an acknowledgement status (e.g., received or not received) of each one of the plurality of data units; wherein, for each of the one-bit flags having a first binary value, the second bitmap has a corresponding segment of bits representing the acknowledgement statuses of the data units of the respective one of the sections; and wherein, for each one of the one-bit flags having a second binary value, the second bitmap does not have a corresponding segment of bits.

In some embodiments of any of the above apparatus, for each one of the one-bit flags having the second binary value, all of the data units of the respective one of the sections have a same acknowledgement status.

According to yet another example embodiment, provided is a method, comprising generating a BA frame, said generating including the steps of: generating a first bitmap having a sequence of one-bit flags, each one of the one-bit flags of the sequence corresponding to a respective one of sections of sequence numbers of a plurality of data units; generating a second bitmap having encoded therein an acknowledgement status of each data unit of the plurality of data units; and arranging the first and second bitmaps in an information field of the BA frame; wherein, for a one-bit flag of the sequence having a first binary value, the second bitmap has a corresponding segment of bits representing acknowledgement statuses of the data units of the respective one of the sections; and wherein, for a one-bit flag of the sequence having a second binary value, the second bitmap does not have a corresponding segment of bits.

According to yet another example embodiment, provided is a method, comprising decoding a received BA frame to determine acknowledgement statuses of a transmitted plurality of data units, said decoding including the steps of: reading a first bitmap of an information field of the BA frame, the first bitmap having a sequence of one-bit flags, each one of the one-bit flags of the sequence corresponding to a respective one of sections of sequence numbers of the plurality of data units; and decoding a second bitmap of the information field, the second bitmap having encoded therein an acknowledgement status of each one of the plurality of data units; wherein, for a one-bit flag of the sequence having a first binary value, the second bitmap has a corresponding segment of bits representing the acknowledgement statuses of the data units of the respective one of the sections; and wherein, for a one-bit flag of the sequence having a second binary value, the second bitmap does not have a corresponding segment of bits.

According to yet another example embodiment, provided is an apparatus, comprising: means for generating a first bitmap having a sequence of one-bit flags, each one of the one-bit flags of the sequence corresponding to a respective one of sections of sequence numbers of a plurality of data units; means for generating a second bitmap having encoded therein an acknowledgement status of each data unit of the plurality of data units; and means for arranging the first and second bitmaps in an information field of a BA frame; wherein, for a one-bit flag of the sequence having a first binary value, the second bitmap has a corresponding segment of bits representing acknowledgement statuses of the data units of the respective one of the sections; and wherein, for a one-bit flag of the sequence having a second binary value, the second bitmap does not have a corresponding segment of bits.

According to yet another example embodiment, provided is an apparatus, comprising: means for reading a first bitmap of an information field of a BA frame, the first bitmap having a sequence of one-bit flags, each one of the one-bit flags of the sequence corresponding to a respective one of sections of sequence numbers of a transmitted plurality of data units; and means for decoding a second bitmap of the information field, the second bitmap having encoded therein an acknowledgement status of each one of the plurality of data units; wherein, for a one-bit flag of the sequence having a first binary value, the second bitmap has a corresponding segment of bits representing the acknowledgement statuses of the data units of the respective one of the sections; and wherein, for a one-bit flag of the sequence having a second binary value, the second bitmap does not have a corresponding segment of bits.

### BRIEF DESCRIPTION OF THE DRAWINGS

Other aspects, features, and benefits of various disclosed embodiments will become more fully apparent, by way of example, from the following detailed description and the accompanying drawings, in which:

FIG. 1 shows a flowchart of a BA session using which at least some embodiments may be practiced;

FIG. 2 shows a block diagram of an example communication system in which at least some embodiments may be practiced;

FIG. 3 shows a schematic diagram of a BA frame that can be transmitted during the BA session of FIG. 1 according to an embodiment;

FIG. 4 illustrates example encoding of a size subfield of the BA frame of FIG. 3 according to an embodiment;

FIG. 5 illustrates example encoding of a segment-number subfield of the BA frame of FIG. 3 according to an embodiment;

FIG. 6 illustrates example encoding of a fragment-number subfield of the BA frame of FIG. 3 according to an embodiment;

FIGS. 7A-7B show flowcharts of a method of generating a Block Ack bitmap of the BA frame of FIG. 3 according to an embodiment;

FIG. 8 shows a flowchart of a method of determining the acknowledgement statuses of individual data units based on a corresponding Block Ack bitmap of the BA frame of FIG. 3 according to an embodiment;

FIGS. 9A-9B illustrate possible estimated improvements that may be achievable according to example embodiments; and

FIG. 10 shows a block diagram of a station that can be used in the communication system of FIG. 2 according to an embodiment.

### DETAILED DESCRIPTION

The following acronyms/abbreviations are used in the description of various embodiments and/or in the accompanying drawings:
ACK Acknowledgement;
ADDBA Add Block Acknowledgement;
A-MPDU Aggregated MAC Packet Data Unit;
AMSDU Aggregated MAC Service Data Unit;
AP Access Point;
BA Block Acknowledgement;
DELBA Delete Block Acknowledgement;
DSAF Distribution System Access Function;
FCS Frame Check Sequence;
FN Fragment Number;
IEEE Institute of Electrical and Electronics Engineers;
QoS Quality of Service;
MAC Medium Access Control;
MLD Multi-Link Device;
MMPDU MAC Management Protocol Data Unit;
MPDU MAC Packet Data Unit;
MSDU MAC Service Data Unit;
nAP non-AP;
PHY Physical Layer;
RA Receiver Address;
SIFS Short Inter Frame Space;
STA Station;
TA Transmitter Address;
TID Traffic Identifier;
WM Wireless Medium.

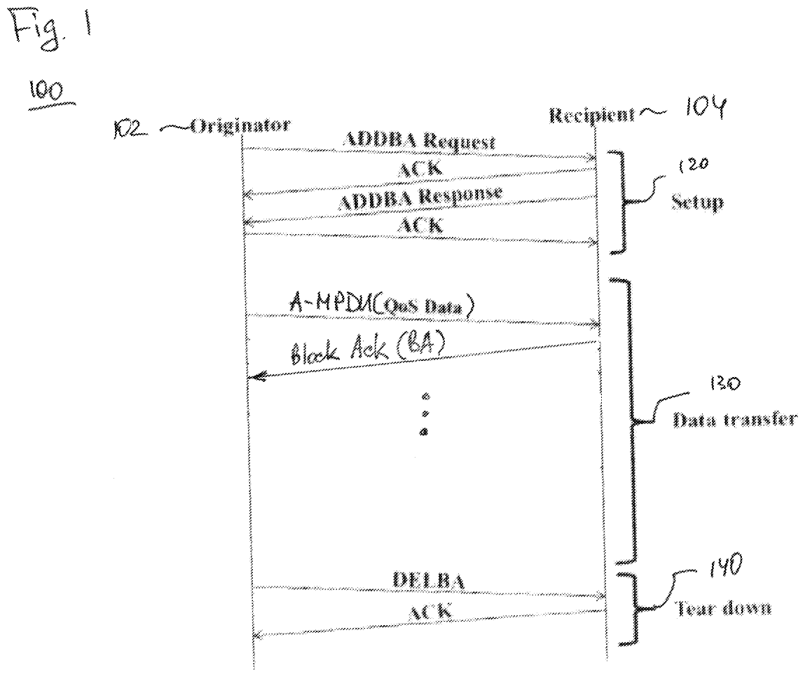

FIG. 1 shows a flowchart of a BA session 100 using which at least some embodiments may be practiced. Session 100 includes transmissions between an originator device 102 and a recipient device 104, which occur during a setup part 120, a data-transfer part 130, and a teardown part 140 of the session. In each individual BA agreement, one device acts as an originator device, and another device acts as a recipient device. Depending on the particular BA agreement, an access point (AP) may act as the originator device while a non-AP station (nAP STA) acts as a recipient device, or vice versa.

Herein, STA denotes a basic addressable unit for 802.11 communications, e.g., a logical entity that is a singly addressable instance of a medium access control (MAC) and physical layer (PHY) interface to the wireless medium (WM). An AP is an entity that contains at least one station and provides access to the distribution system services, via the wireless medium, for other associated stations. As such, an AP comprises a STA and a distribution system access function (DSAF). A non-AP station is a station that is not a part of an access point.

During the setup part 120, originator device 102 sends an add BA (ADDBA) request frame to establish session 100. The ADDBA-request frame typically includes a traffic identifier (TID), signaling the access category of session 100 to recipient device 104. The ADDBA-request frame may also indicate the BA policy and block size recommended by originator device 102. Recipient device 104 may use the recommended block size, e.g., to set an appropriate buffer size for the session. If the ADDBA-request frame is correctly received, then recipient device 104 answers with an acknowledgment (ACK) frame followed by an ADDBA-response frame. Using the corresponding fields of the ADDBA-request and ADDBA-response frames, originator device 102 and recipient device 104 may agree on the use of aggregated MAC packet data units (A-MPDUs). The acceptance or refusal of the session may also be declared within the ADDBA-response frame. Originator device 102 answers to the ADDBA-response frame with its own ACK frame. Originator device 102 and recipient device 104 may continue setup part 120 by negotiating one or more additional/other BA agreements.

Upon successful completion of the setup part 120, originator device 102 may start the data-transfer part 130 by sending QoS data frames in an A-MPDU. In response to the A-MPDU transmitted by originator device 102, recipient device 104 generates and transmits a corresponding BA frame. If a MAC packet data unit (MPDU) is indicated in the BA frame as “not received,” then originator device 102 may retransmit the corresponding QoS data frame until its lifetime inactivity limit is reached or up to a maximum retransmission time. A similar sequence may be used to transmit one or more additional A-MPDUs.

Session 100 may be terminated, e.g., when originator device 102 has no more QoS data frames to send to recipient device 104. The corresponding teardown part 140 includes transmission, by originator device 102, of a delete BA (DELBA) frame. If the DELBA frame is successfully received, then recipient device 104 responds with a corresponding ACK frame, after which session 100 terminates. In general, either originator device 102 or recipient device 104 may initiate the teardown part 140 by transmitting the corresponding DELBA frame.

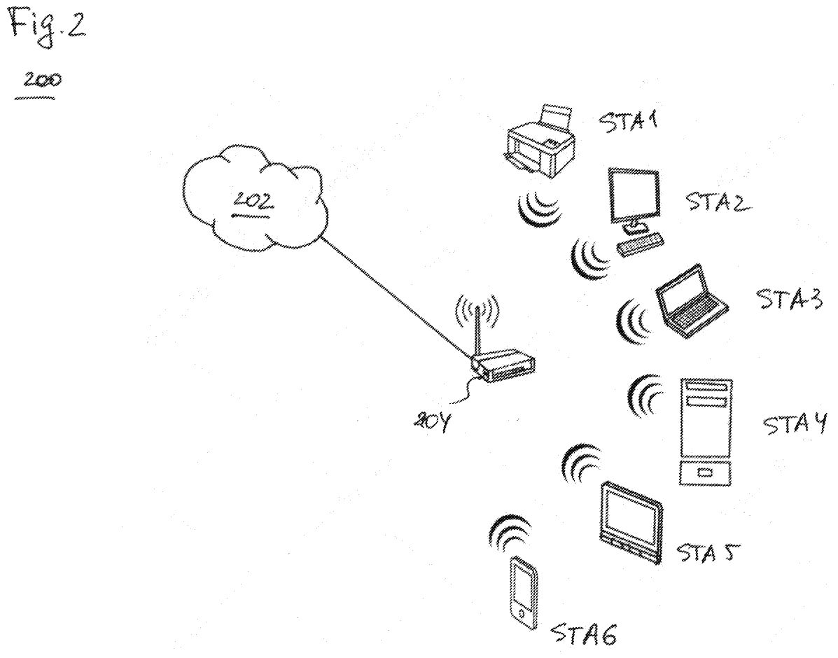

FIG. 2 shows a block diagram of an example communication system 200 in which at least some embodiments may be practiced. System 200 comprises an AP 204 connected to one or more networks (e.g., the Internet) 202, e.g., as indicated in FIG. 2. In operation, AP 204 provides wireless access to the network(s) 202 for a plurality of nAP stations, illustratively STA1-STA6. Depending on the particular configuration of system 200, more or fewer than six nAP stations may be served by AP 204. Individual ones of the nAP stations may be selected from the device set including, e.g., a printer, a desktop computer, a laptop computer, a server, a tablet, a smartphone, etc. Each of the stations STA1-STA6 may send and receive data using a respective instance of BA session 100 (FIG. 1) established with AP 204.

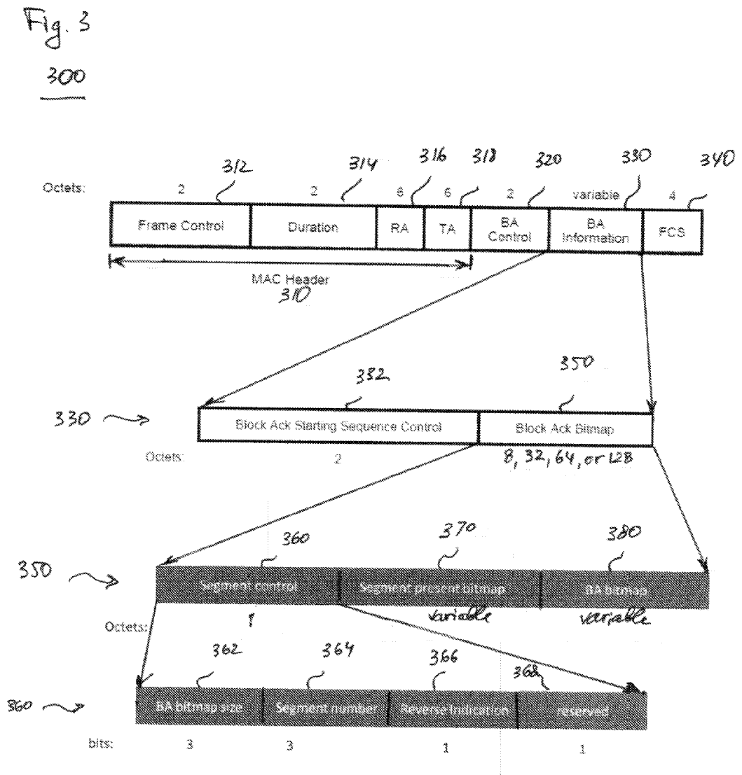

FIG. 3 shows a schematic diagram of a BA frame 300 that can be transmitted during session 100 according to an embodiment. BA frame 300 includes a MAC header 310, a BA control field 320, a BA information field 330, and a frame check sequence (FCS) field 340. MAC header 310 includes a frame control field 312, a duration field 314, a receiver address (RA) field 316, and a transmitter address (TA) field 318. Frame control field 312 may be used to indicate the protocol version, the type and subtype of the frame, and other parameters known to persons of ordinary skill in the pertinent art. Duration field 314 may be used to specify the time needed to transmit frame 300 plus a SIFS duration. RA field 316 specifies the address of originator device 102 of session 100. TA field 318 specifies the address of the station transmitting BA frame 300, i.e., of recipient device 104 (also see FIG. 1). A more-detailed description of MAC header 310 and BA control field 320 can be found, e.g., in the IEEE 802.11 standard.

Drop-down expansions shown in FIG. 3 show schematic diagrams of BA information field 330 according to an embodiment. As shown, BA information field 330 includes a Block-Ack-starting-sequence-control field 332 and a Block-Ack bitmap 350. Block-Ack bitmap 350 includes a segment-control field 360, a segment-present bitmap 370, and a BA bitmap 380. Segment-control field 360 is one-octet long. The bitmaps 370 and 380 have variable lengths that can be selected such that the total length of Block-Ack bitmap 350 is, e.g., 8, 32, 64, or 128 octets.

Segment-control field 360 includes a BA-bitmap-size subfield 362, a segment-number subfield 364, a reverse-indication subfield 366, and a reserved (for future use) subfield 368. The subfields 362, 364, 366, and 368 have the lengths of 3, 3, 1 and 1 bit(s), respectively.

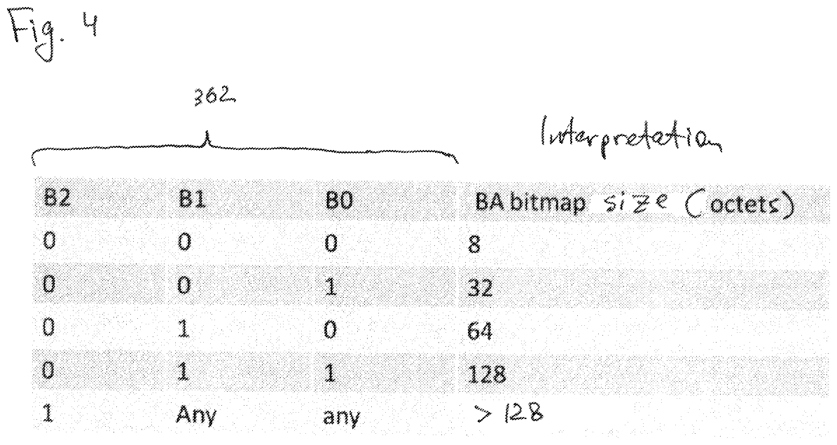

FIG. 4 illustrates example encoding of subfield 362 according to an embodiment. The three bits of subfield 362 are denoted as B2, B1, and B0, respectively, and their binary values are given in the corresponding columns of the shown table. The rightmost column of the table indicates the interpretation of different binary values of subfield 362. More specifically, each of the numbers in the rightmost column indicates the maximum number of MPDUs in an A-MPDU corresponding to the 3-bit value of subfield 362 in the same row of the table.

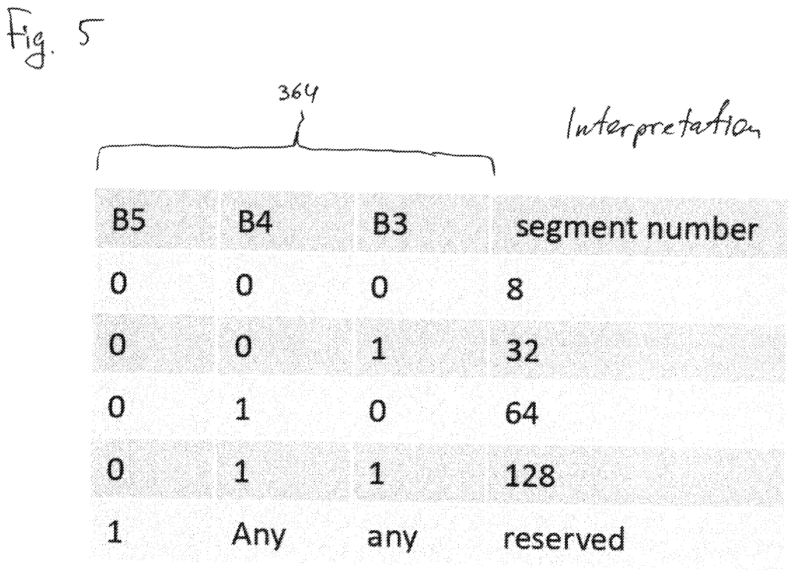

FIG. 5 illustrates example encoding of segment-number subfield 364 according to an embodiment. The three bits of subfield 364 are denoted as B5, B4, and B3, respectively, and their binary values are given in the corresponding columns of the shown table. The rightmost column of the table indicates the interpretation of different binary values of subfield 364. More specifically, each of the numbers in the rightmost column indicates how many equal-size segments cover the maximum bitmap size corresponding to the 3-bit value of subfield 364 in the same row of the table.

Referring back to FIG. 3, the bit value of reverse-indication subfield 366 sets the interpretation rule for BA bitmap 380. More specifically, the binary 0 in subfield 366 means that any binary “1” in the corresponding BA bitmap 380 represents a received MPDU, whereas any binary “0” represents an MPDU that has not been received. The binary “1” in subfield 366 means that the interpretation is flipped, i.e., any binary “0” in the corresponding BA bitmap 380 represents a received MPDU, whereas any binary “1” represents an MPDU that has not been received.

The segment-present bitmap 370 carries a plurality of segment flags, with each flag being encoded by a single bit. An individual segment flag of bitmap 370 is set to binary “1” if at least one bit is set to binary “1” in the corresponding segment of BA bitmap 380. Otherwise, the segment flag is set to binary “0”, and the corresponding segment of BA bitmap 380 is not present therein, i.e., is omitted and is not transmitted.

Each bit in BA bitmap 380 indicates the acknowledgement status of the corresponding MPDU. More specifically, if the specific bit of BA bitmap 380 is set to binary “1”, then the interpretation is that the corresponding MPDU is received (not received) when the corresponding reverse-indication subfield 366 has a binary “0” (binary “1”). In other words, the way in which the BA bitmap 380 is interpreted depends on the binary value (i.e., 0 or 1) specified in the reverse-indication subfield 366.

Reverse-indication subfield 366 enables omission of an entire segment from BA bitmap 380 if all of the corresponding MPDUs have not been received (reverse indication value of 0) and if all of the corresponding MPDUs have been received (reverse indication value of 1). Under certain wireless-channel conditions, such segment omissions may result in a significant size reduction of BA bitmap 380 and, as such, may beneficially reduce the BA-related overhead.

Using the above-described information encoded in BA frame 300, originator device 102 can determine the acknowledgement status of each MSDU or MPDU of the corresponding block, e.g., as follows.

If the reverse-indication subfield 366 has a binary 0, then Eqs. (1)-(4) can be used to map sequence numbers of MSDUs and MPDUs onto the bit positions in BA bitmap 380 as follows:

$$x ( s ) = \frac{{N}_{x} - {N}_{0}}{8 M / m} + 1 \qquad ( 1 )$$

where x(s) is the position of segment s; Nₓ is the sequence number of the corresponding MSDU or MPDU; N₀ is the start sequence number; M is the size of the BA bitmap in octets; and m is the segment number;

$$R ( x ) = ( {N}_{x} - {N}_{0} ) mod ( 8 M / m ) \qquad ( 2 )$$

where R(x) is the relative position of Nₓ in the corresponding segment s;

$$F ( x ) = Y \times ( 8 M / m ) + R ( x ) \qquad ( 3 )$$

$$Y = g ( x ( s ) ) \qquad ( 4 )$$

where F(x) is the position in BA bitmap 380 corresponding to Nₓ; and g(x(s)) is a mapping function that takes into account the number of binary zeros and ones in segment-present bitmap 370 before the position corresponding to Nₓ.

Using the mapping defined by Eqs. (1)-(4), the acknowledgement status of different MPDUs can be determined as follows:
(a) If the bit value at position x(s) is a binary 0, then the corresponding segment is not present in bitmap 380 and the corresponding acknowledgement statuses are all represented by binary “0s”; and
(b) If the bit value at position x(s) is a binary 1, then the acknowledgement status of the frame having the sequence number Nₓ is given by the bit value corresponding to position F(x).

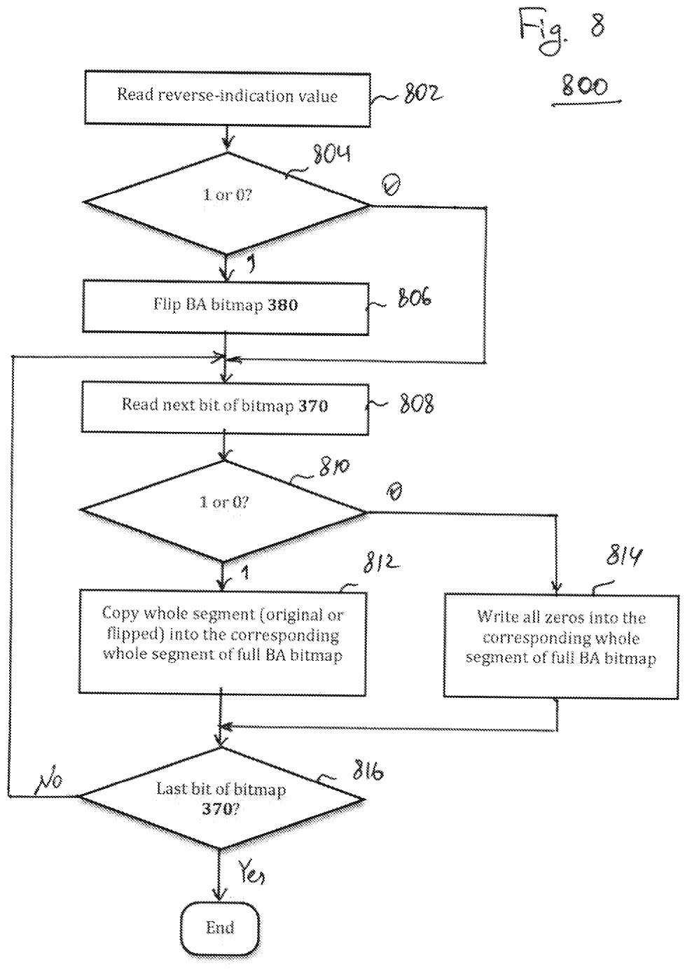

Based on the description provided above, a person of ordinary skill in the pertinent art will readily understand how to derive similar equations and rules corresponding to the binary 1 in the reverse-indication subfield 366. Method 800 described below in reference to FIG. 8 further illustrates decoding processing of bitmaps 370 and 380 exemplified by Eqs. (1)-(4).

Some embodiments may be used for transmitting data units, during data-transfer part 130 of session 100, using fragmentation, which may result in more-efficient use of resources. As used herein, the term “fragmentation” generally refers to a process of partitioning a data unit, such as an AMSDU or a MAC management protocol data unit (MMPDU), into smaller data units for transmission. The term “defragmentation” generally refers to a process of reassembling the original AMSDU or MMPDU from the corresponding fragments.

For example, if both originator device 102 and recipient device 104 adopt Level 3 dynamic fragmentation, an MPDU (AMSDU or MMPDU) can be divided into four fragments, for which four bits in Block-Ack bitmap 350 can be used to indicate the acknowledgement status of that MPDU. Interpretation of such four bits is controlled by a corresponding four-bit fragment-number subfield of Block Ack bitmap 350.

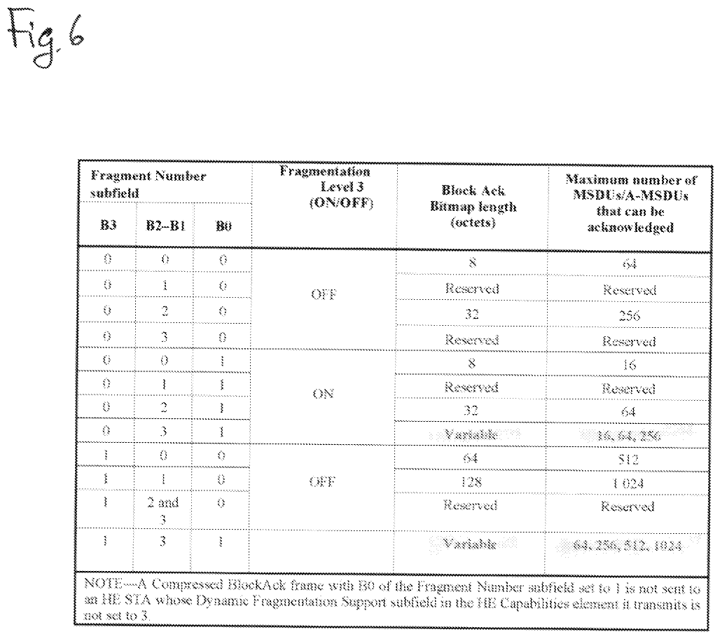

FIG. 6 illustrates example encoding of a fragment-number subfield of Block Ack bitmap 350 according to an embodiment. The four bits of the fragment-number subfield are labeled as B0, B1, B2, and B3, respectively. Different values indicated by the bits B0-B3 are given in the corresponding columns of the shown table. The effect of the different values of the bits B0-B3 on the BA functionality is indicated in the next three columns of the table. Example embodiments disclosed herein may correspond to the following values of the bits B0-B3: B0=0; B1=1; B2=1; B3=1.

Using Block Ack bitmap 350 having fragment-number subfields encoded as indicated in FIG. 6, originator device 102 can determine the acknowledgement status of each fragmented data unit of the corresponding block, e.g., as follows.

If the reverse-indication subfield 366 has a binary 0, then Eqs. (5)-(8) can be used to map sequence numbers and fragment numbers of fragmented data units onto the bit positions in BA bitmap 380 as follows:

$$x ( s ) = \frac{{N}_{x} - {N}_{0}}{8 M / 4 m} + 1 \qquad ( 5 )$$

where x(s) is the position of segment s; Nₓ is the sequence number of the corresponding data unit; N₀ is the start sequence number; M is the size of the BA bitmap in octets; and m is the segment number;

$$R ( x ) = ( {N}_{x} - {N}_{0} ) mod ( 8 M / 4 m ) \qquad ( 6 )$$

where R(x) is the relative position of Nₓ in the corresponding segment s;

$$F ( x , y ) = Z \times ( 8 M / m ) + 4 R ( x ) + y \qquad ( 7 )$$

$$Z = G ( x ( s ) ) \qquad ( 8 )$$

where F(x,y) are the positions in BA bitmap 380 corresponding to the fragments of Nₓ; y=0, 1, 2, 3; and G(x(s)) is a mapping function that takes into account the number of binary zeros and ones in segment-present bitmap 370 before the positions corresponding to Nₓ.

Using the mapping defined by Eqs. (5)-(8), the acknowledgement status of different fragmented data units can be determined as follows:
(a) If the bit value at position x(s) is a binary 0, then the status of all fragments of the frame having the sequence number Nₓ is “not received;” and
(b) If the bit value at position x(s) is a binary 1, then the acknowledgement status of the individual fragments of the frame having the sequence number Nₓ is given by the bit values corresponding to positions F(x, y).

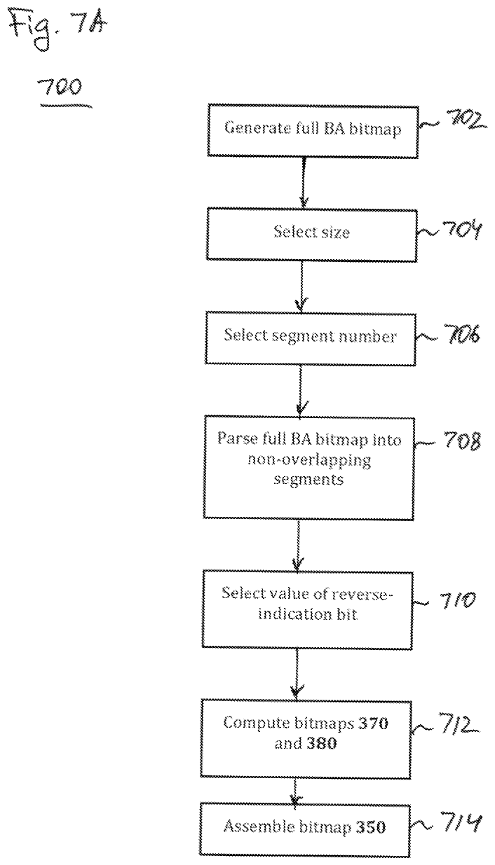

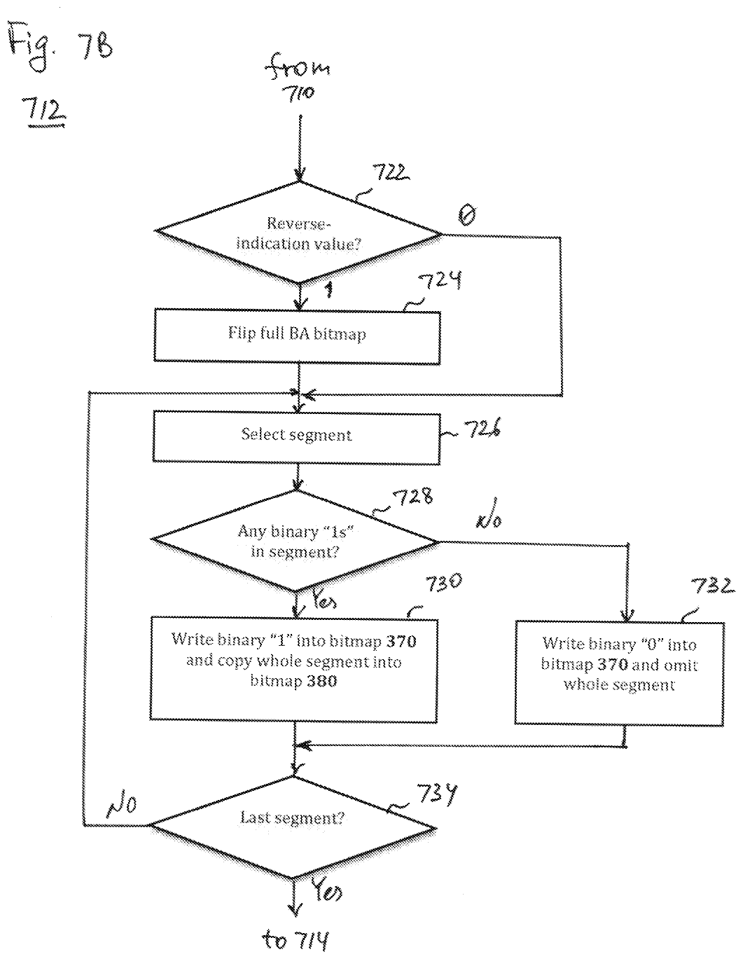

FIGS. 7A-7B show flowcharts of a method 700 of generating Block-Ack bitmap 350 according to an embodiment. More specifically, FIG. 7A shows the overall flowchart of method 700. FIG. 7B shows a flowchart of step 712 of method 700 according to an embodiment. Method 700 can be implemented, e.g., at recipient device 104 (FIG. 1). For clarity, method 700 is described herein below in reference to non-fragmented transmission. Based on the provided description, a person of ordinary skill in the pertinent art will be able to appropriately modify method 700 for fragmented transmission, without any undue experimentation.

At step 702 of method 700, recipient device 104 operates to generate a full BA bitmap for the block of frames transmitted during data-transfer part 130 of session 100. Herein, the term “full” means that the BA bitmap generated at step 702 has an entry (i.e., a bit) dedicated to each data unit within the relevant range of sequence numbers, i.e., there is a one-to-one mapping between different bits of the full BA bitmap and different sequence numbers. For example, if a particular data unit is received, then the full BA bitmap has a binary one at the position corresponding to the unit's sequence number. Alternatively, if that particular data unit is not received, then the full BA bitmap has a binary zero at that position.

At step 704, recipient device 104 operates to select the BA-bitmap size to be encoded in subfield 362. Such size may be selected, e.g., based on the number of transmitted data units. The selected size is then encoded in subfield 362, e.g., using the encoding shown in FIG. 4.

At step 706, recipient device 104 operates to select the segment number to be encoded in subfield 364. Such number may be selected, e.g., from a corresponding look-up table and/or based on the specific binary contents of the full BA bitmap of step 702. The selected segment number is then encoded in subfield 364, e.g., using the encoding shown in FIG. 5.

At step 708, recipient device 104 operates to parse the full BA bitmap of step 702 into non-overlapping segments of equal length such that the length of each segment is equal to the BA bitmap size of step 704 divided by the segment number of step 706.

At step 710, recipient device 104 operates to select the value of the reverse-indication bit 366. The value of the reverse-indication bit 366 may be selected based on the binary contents of individual segments parsed at step 708, e.g., to optimize (e.g., approximately minimize) the final size of BA bitmap 380.

At step 712, recipient device 104 operates to compute bitmaps 370 and 380. The computation of step 712 can be performed, e.g., in accordance with the flowchart shown in FIG. 7B.

Referring to FIG. 7B, sub-step 722 of step 712 is used to direct the processing of step 712 either to sub-step 724 or to sub-step 726. More specifically, if the value of reverse-indication bit 366 is binary “1”, then the processing is directed to sub-step 724. If the value of reverse-indication bit 366 is binary “0”, then sub-step 724 is bypassed, and the processing is directed to sub-step 726.

At sub-step 724, the bit values of the full BA bitmap of step 702 are flipped without any changes to the parsing performed at step 708.

Sub-steps 726-734 implement segment-by-segment processing of the full BA bitmap. Depending on the result of sub-step 722, the full BA bitmap may be processed either in the form originally generated at step 702 or in the “flipped” form generated at sub-step 724.

At sub-step 726, a next segment of the full BA bitmap is selected. For the first instance of step 726, the first segment of the full BA bitmap is selected.

At sub-step 728, it is determined whether or not the selected segment has any binary “1s” therein. If the selected segment has at least one binary “1” therein, then the processing of step 712 is directed to sub-step 730. Otherwise, the processing of step 712 is directed to sub-step 732.

At sub-step 730, recipient device 104 operates to write a binary “1” into the position of bitmap 370 corresponding to the selected segment. Recipient device 104 further operates to copy the whole segment from the full BA bitmap into bitmap 380.

At sub-step 732, recipient device 104 operates to write a binary “0” into the position of bitmap 370 corresponding to the selected segment. Recipient device 104 further operates to omit the whole segment, i.e., the selected segment of the full BA bitmap is not copied into bitmap 380.

At sub-step 734, it is determined whether or not the processed segment is the last segment of the full BA bitmap. If the processed segment is the last segment of the full BA bitmap, then the processing of step 712 is terminated, i.e., the processing of method 700 is directed to step 714. Otherwise, the processing of step 712 is directed back to sub-step 726.

Referring back to FIG. 7A, at step 714 of method 700, Block-Ack bitmap 350 is assembled using the subfield 362 generated at step 704, subfield 364 generated at step 704, reverse-indication bit 366 of step 710, and bitmaps 370 and 380 of step 712.

FIG. 8 shows a flowchart of a method 800 of determining the acknowledgement statuses of individual data units based on Block-Ack bitmap 350 according to an embodiment. Method 800 can be implemented, e.g., at originator device 102 (FIG. 1). For clarity, method 800 is described herein below in reference to non-fragmented transmission. Based on the provided description, a person of ordinary skill in the pertinent art will be able to appropriately modify method 800 for fragmented transmission, without any undue experimentation.

Method 800 begins at step 802, wherein the value of reverse-indication bit 366 is read from the received BA frame 300.

Step 804 is used to direct the processing of method 800 either to step 806 or to step 808. More specifically, if the value of reverse-indication bit 366 is binary “1”, then the processing is directed to step 806. If the value of reverse-indication bit 366 is binary “0”, then step 806 is bypassed, and the processing is directed to step 808.

At step 806, the bit values of BA bitmap 380 are flipped.

Steps 808-816 implement segment-by-segment regeneration of the full BA bitmap based on bitmaps 370 and 380. Depending on the result of step 804, the full BA bitmap may be regenerated either from the received BA bitmap 380 or from the “flipped” form thereof generated at step 806.

At step 808, the value of a next bit of bitmap 370 is read from the received BA frame 300. For the first instance of step 808, the first bit of bitmap 370 is read.

Step 810 is used to direct the processing of method 800 either to step 812 or to step 814. More specifically, if the bit value read at step 808 is a binary “1”, then the processing is directed to step 812. If the bit value read at step 808 is a binary “0”, then the processing is directed to step 814.

At step 812, originator device 102 operates to copy the whole corresponding segment of original or flipped bitmap 380 into the corresponding segment of the full BA bitmap that is being regenerated.

At step 814, originator device 102 operates to write all zeros into the corresponding segment of the full BA bitmap that is being regenerated.

At step 816, it is determined whether or not the current bit of bitmap 370 is the last bit thereof. If the current bit of bitmap 370 is the last bit thereof, then the processing of method 800 is terminated. Otherwise, the processing of method 800 is directed back to step 808.

The above-described use of BA frame 300 in system 200 may provide one or more of the following benefits:
(1) Compatibility with currently standardized BA mechanisms and with possible extensions thereof directed at larger BA lengths, such as 2048, 4096, etc.;
(2) Compatibility with both fragmented transmission and non-fragmented transmission of data units;
(3) Reduction in the BA overhead under at least some wireless-channel conditions;
(4) Most significant reductions in the BA overhead when most of the MPDUs have the same acknowledgement status (e.g., received or not received);
(5) When system 200 is subjected to fluctuating wireless-channel conditions and/or varying levels of interference, some embodiments are capable of dynamically adjusting the segment number 364 (e.g., at step 706, FIG. 7A) and/or the bitmap size 362 (e.g., at step 704, FIG. 7A) to maintain the BA overhead at an optimal (e.g., approximately minimal) level despite the fluctuations.

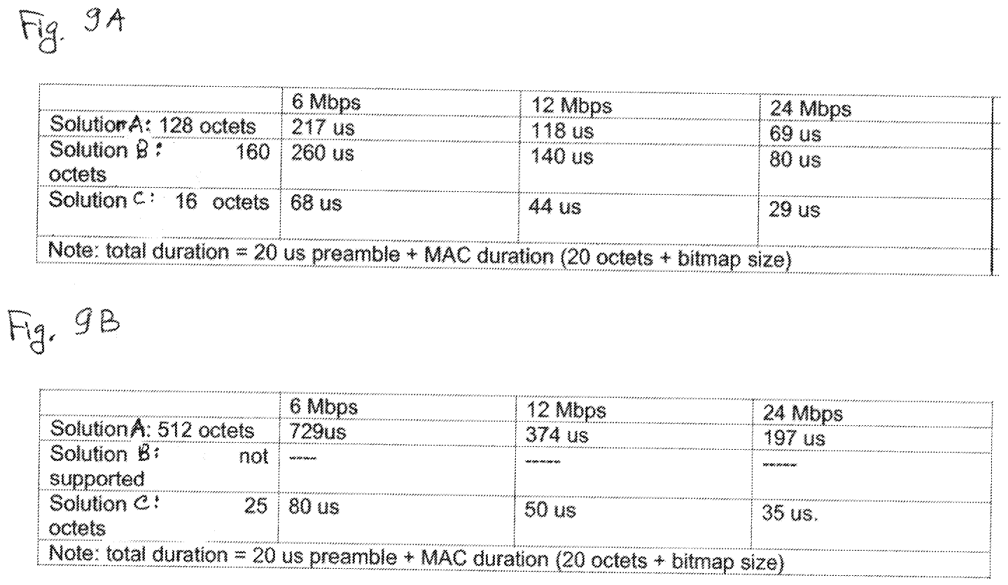

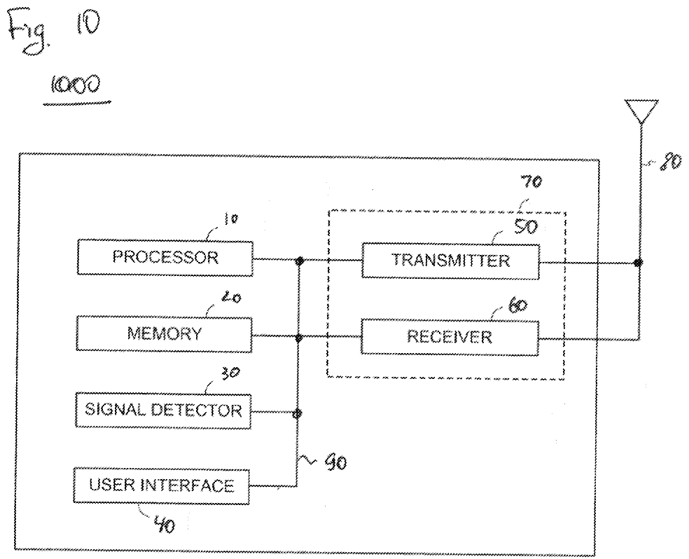

FIGS. 9A-9B illustrate possible estimated improvements that may be achievable according to example embodiments. More specifically, the performance estimates shown in FIG. 9A correspond to transmission of non-fragmented data units at three different data rates, i.e., 6, 12, and 24 Mbps. The performance estimates shown in FIG. 9B correspond to transmission of fragmented data units at those three data rates as well.

The data shown in FIG. 9A correspond to the transmission, by originator device 102, of 1024 MPDUs aggregated in an AMPDU, wherein only the first and last MPDUs are received by recipient device 104. It is assumed that recipient device 104 can generate and transmit the corresponding BA frame using any one of three different BA mechanisms, which are referred to as Solutions A, B, and C, respectively. Solution A uses the Compressed BA mechanism of the above-cited IEEE 802.1 lax standard. Solution B uses the Reduced BA mechanism disclosed in the draft document IEEE 802.11-20/1780r1 authored by Shawn Sanghyun Kim, et al. and entitled “Reduced BlockAck,” which is incorporated herein by reference in its entirety. Solution C uses the above-described BA frame 300.

As indicated in the first column of the table shown in FIG. 9A, the lengths of the BA bitmaps for Solutions A, B, and C are 128, 160, and 16 octets, respectively. Comparison of the durations of the corresponding BA frames listed for each of the three data rates clearly indicates that Solution C beneficially produces the shortest BA frames in each case.

The data shown in FIG. 9B correspond to the transmission, by originator device 102, of 1024 MPDUs aggregated in an AMPDU with Level 3 fragmentation enabled at both sides, wherein only the first fragment of the first MPDU and the last fragment of the last MPDU are received by recipient device 104. Again, the above-mentioned Solutions A, B, and C are compared.

Solution B does not support fragmentation. As indicated in the first column of the table shown in FIG. 9B, the lengths of the BA bitmaps for Solutions A and C are 512 and 25 octets, respectively. Comparison of the durations of the corresponding BA frames listed for each of the three data rates clearly indicates that Solution C beneficially produces shorter BA frames than Solution A in each case.

FIG. 10 shows a block diagram of a station (STA) 1000 that can be used in system 200 according to an embodiment. Various embodiments of station 1000 may be incorporated into AP 204 and/or any of nAP stations STA1-STA6 (also see FIG. 2). As shown, station 1000 comprises a processor 10, a memory 20, a signal detector 30, a user interface 40, a transceiver 70, and an antenna 80. Transceiver 70 comprises a transmitter 50 and a receiver 60, both connected to antenna 80. Various components of station 1000 are interconnected by a bus 90.

In operation, processor 10 may perform processing based on program instructions stored in memory 20. Some of the program instructions may be executable to implement methods disclosed herein. For example, when station 1000 operates as originator device 102, processor 10 may be configured to execute method 800. Alternatively, when station 1000 operates as recipient device 104, processor 10 may be configured to execute method 700.

Transmitter 50 may be used to wirelessly transmit communication signals carrying data packets, units, and frames. Receiver 60 may be used to wirelessly receive communication signals carrying data packets, units, and frames. Signal detector 30 may be used to detect and measure the signals received by receiver 60. For example, signal detector 30 may measure signal energy, energy per subcarrier and/or per symbol, power spectral density, etc.

User interface 40 may comprise a keypad, a microphone, a speaker, and/or a display (not explicitly shown in FIG. 10). For example, user interface 40 may be used to convey information to a user and/or to receive inputs from the user.

According to an example embodiment disclosed above, e.g., in the summary section and/or in reference to any one or any combination of some or all of the embodiments of FIGS. 1-10, provided is an apparatus, comprising a wireless transceiver (e.g., 70, FIG. 10) and a processor (e.g., 10, FIG. 10) connected to the wireless transceiver to generate therefor a block-acknowledgement (BA) frame (e.g., 300, FIG. 3) in response to a plurality of data units (e.g., QoS Data, FIG. 1) externally wirelessly transmitted to the wireless transceiver, the BA frame including a BA information field (e.g., 330, FIG. 3); wherein the BA information field comprises: a first bitmap (e.g., 370, FIG. 3) having a sequence of one-bit flags, each one of the one-bit flags corresponding to a respective one of non-overlapping sections of sequence numbers of the plurality of data units; and a second bitmap (e.g., 380, FIG. 3) having encoded therein an acknowledgement status (e.g., received or not received) of each one of the plurality of data units; wherein, for each of the one-bit flags having a first binary value, the second bitmap has a corresponding segment of bits representing acknowledgement statuses of the data units of the respective one of the sections; and wherein, for each one of the one-bit flags having a second binary value, the second bitmap does not have a corresponding segment of bits.

In some embodiments of the above apparatus, for each one of the one-bit flags having the second binary value, all of the data units of the respective one of the sections have a same acknowledgement status.

In some embodiments of any of the above apparatus, the same acknowledgement status is “received.”

In some embodiments of any of the above apparatus, the same acknowledgement status is “not received.”

In some embodiments of any of the above apparatus, the second bitmap has a variable length.

In some embodiments of any of the above apparatus, the BA information field further comprises a first segment-control subfield (e.g., 362, FIGS. 3, 4) having encoded therein a maximum length of the data units.

In some embodiments of any of the above apparatus, the BA information field further comprises a second segment-control subfield (e.g., 364, FIGS. 3, 5) having encoded therein a number of equal-length segments in the maximum length.

In some embodiments of any of the above apparatus, each of the corresponding segments of bits of the second bitmap has a length equal to the maximum length divided by the number of equal-length segments.

In some embodiments of any of the above apparatus, the BA information field comprises a control bit (e.g., 366, FIG. 3) whose binary value determines interpretation of binary “0s” and “1s” of the second bitmap in terms of the acknowledgement status.

In some embodiments of any of the above apparatus, the apparatus comprises an access point (e.g., 204, FIG. 2); and wherein the access point includes the wireless transceiver and the processor.

In some embodiments of any of the above apparatus, the apparatus comprises a non-access-point station (e.g., one of STA1-STA6, FIG. 2); and wherein the non-access-point station includes the wireless transceiver and the processor.

According to another example embodiment disclosed above, e.g., in the summary section and/or in reference to any one or any combination of some or all of the embodiments of FIGS. 1-10, provided is an apparatus, comprising a wireless transceiver (e.g., 70, FIG. 10) and a processor (e.g., 10, FIG. 10) connected to the wireless transceiver to determine acknowledgement statuses of a transmitted plurality of data units (e.g., QoS Data, FIG. 1) based on a received block-acknowledgement (BA) frame (e.g., 300, FIG. 3), which includes a BA information field (e.g., 330, FIG. 3); wherein the BA information field comprises: a first bitmap (e.g., 370, FIG. 3) having a sequence of one-bit flags, each one of the one-bit flags corresponding to a respective one of non-overlapping sections of sequence numbers of the plurality of data units; and a second bitmap (e.g., 380, FIG. 3) having encoded therein an acknowledgement status (e.g., received or not received) of each one of the plurality of data units; wherein, for each of the one-bit flags having a first binary value, the second bitmap has a corresponding segment of bits representing the acknowledgement statuses of the data units of the respective one of the sections; and wherein, for each one of the one-bit flags having a second binary value, the second bitmap does not have a corresponding segment of bits.

In some embodiments of the above apparatus, for each one of the one-bit flags having the second binary value, all of the data units of the respective one of the sections have a same acknowledgement status.

In some embodiments of any of the above apparatus, the same acknowledgement status is “received.”

In some embodiments of any of the above apparatus, the same acknowledgement status is “not received.”

In some embodiments of any of the above apparatus, the second bitmap has a variable length.

In some embodiments of any of the above apparatus, the BA information field further comprises a first segment-control subfield (e.g., 362, FIGS. 3, 4) having encoded therein a maximum length of the data units.

In some embodiments of any of the above apparatus, the BA information field further comprises a second segment-control subfield (e.g., 364, FIGS. 3, 5) having encoded therein a number of equal-length segments in the maximum length.

In some embodiments of any of the above apparatus, each of the corresponding segments of bits of the second bitmap has a length equal to the maximum length divided by the number of equal-length segments.

In some embodiments of any of the above apparatus, the BA information field comprises a control bit (e.g., 366, FIG. 3) whose binary value determines interpretation, by the processor, of binary “0s” and “1s” of the second bitmap in terms of the acknowledgement status.

In some embodiments of any of the above apparatus, the apparatus comprises an access point (e.g., 204, FIG. 2); and wherein the access point includes the wireless transceiver and the processor.

In some embodiments of any of the above apparatus, the apparatus comprises a non-access-point station (e.g., one of STA1-STA6, FIG. 2); and wherein the non-access-point station includes the wireless transceiver and the processor.

According to yet another example embodiment disclosed above, e.g., in the summary section and/or in reference to any one or any combination of some or all of the embodiments of FIGS. 1-10, provided is a machine-implemented method, comprising generating a block-acknowledgement (BA) frame, said generating including the steps of: generating (e.g., 712, FIG. 7A) a first bitmap (e.g., 370, FIG. 3) having a sequence of one-bit flags, each one of the one-bit flags of the sequence corresponding to a respective one of sections of sequence numbers of a plurality of data units; generating (e.g., 712, FIG. 7A) a second bitmap (e.g., 380, FIG. 3) having encoded therein an acknowledgement status of each data unit of the plurality of data units; and arranging (e.g., 714, FIG. 7A) the first and second bitmaps in an information field of the BA frame; wherein, for a one-bit flag of the sequence having a first binary value, the second bitmap has a corresponding segment of bits representing acknowledgement statuses of the data units of the respective one of the sections; and wherein, for a one-bit flag of the sequence having a second binary value, the second bitmap does not have a corresponding segment of bits.

In some embodiments of the above method, for the one-bit flag having the second binary value, all of the data units of the respective one of the sections have a same acknowledgement status.

In some embodiments of any of the above methods, at least one of the first and second bitmaps has a variable length.

In some embodiments of any of the above methods, the method further comprises selecting (e.g., 710, FIG. 7A) a binary value for a control bit (e.g., 366, FIG. 3) of the information field to indicate interpretation of binary “0s” and “1s” of the second bitmap in terms of the acknowledgement status.

In some embodiments of any of the above methods, the method further comprises transmitting (e.g., Block Ack, FIG. 1) the BA frame using a wireless transmitter (e.g., 50, FIG. 10).

According to yet another example embodiment disclosed above, e.g., in the summary section and/or in reference to any one or any combination of some or all of the embodiments of FIGS. 1-10, provided is a machine-implemented method, comprising decoding a received block-acknowledgement (BA) frame to determine acknowledgement statuses of a transmitted plurality of data units, said decoding including the steps of: reading (e.g., 810, FIG. 8) a first bitmap (e.g., 370, FIG. 3) of an information field of the BA frame, the first bitmap having a sequence of one-bit flags, each one of the one-bit flags of the sequence corresponding to a respective one of sections of sequence numbers of the plurality of data units; and decoding (e.g., 812, 814, FIG. 8) a second bitmap (e.g., 380, FIG. 3) of the information field, the second bitmap having encoded therein an acknowledgement status of each one of the plurality of data units; wherein, for a one-bit flag of the sequence having a first binary value, the second bitmap has a corresponding segment of bits representing the acknowledgement statuses of the data units of the respective one of the sections; and wherein, for a one-bit flag of the sequence having a second binary value, the second bitmap does not have a corresponding segment of bits.

In some embodiments of the above method, for the one-bit flag having the second binary value, all of the data units of the respective one of the sections have a same acknowledgement status.

In some embodiments of any of the above methods, at least one of the first and second bitmaps has a variable length.

In some embodiments of any of the above methods, the method further comprises reading a binary value of a control bit in the information field to interpret binary “0s” and “1s” of the second bitmap in terms of the acknowledgement status.

In some embodiments of any of the above methods, the method further comprises receiving (e.g., Block Ack, FIG. 1) the BA frame using a wireless receiver (e.g., 60, FIG. 10).

According to yet another example embodiment disclosed above, e.g., in the summary section and/or in reference to any one or any combination of some or all of the embodiments of FIGS. 1-10, provided is an apparatus, comprising: means for generating a first bitmap (e.g., 370, FIG. 3) having a sequence of one-bit flags, each one of the one-bit flags of the sequence corresponding to a respective one of sections of sequence numbers of a plurality of data units; means for generating a second bitmap (e.g., 380, FIG. 3) having encoded therein an acknowledgement status of each data unit of the plurality of data units; and means for arranging the first and second bitmaps in an information field of a block-acknowledgement (BA) frame; wherein, for a one-bit flag of the sequence having a first binary value, the second bitmap has a corresponding segment of bits representing acknowledgement statuses of the data units of the respective one of the sections; and wherein, for a one-bit flag of the sequence having a second binary value, the second bitmap does not have a corresponding segment of bits.

According to yet another example embodiment disclosed above, e.g., in the summary section and/or in reference to any one or any combination of some or all of the embodiments of FIGS. 1-10, provided is an apparatus, comprising: means for reading a first bitmap (e.g., 370, FIG. 3) of an information field of a block-acknowledgement (BA) frame, the first bitmap having a sequence of one-bit flags, each one of the one-bit flags of the sequence corresponding to a respective one of sections of sequence numbers of a transmitted plurality of data units; and means for decoding a second bitmap (e.g., 380, FIG. 3) of the information field, the second bitmap having encoded therein an acknowledgement status of each one of the plurality of data units; wherein, for a one-bit flag of the sequence having a first binary value, the second bitmap has a corresponding segment of bits representing the acknowledgement statuses of the data units of the respective one of the sections; and wherein, for a one-bit flag of the sequence having a second binary value, the second bitmap does not have a corresponding segment of bits.

While this disclosure includes references to illustrative embodiments, this specification is not intended to be construed in a limiting sense. Various modifications of the described embodiments, as well as other embodiments within the scope of the disclosure, which are apparent to persons skilled in the art to which the disclosure pertains are deemed to lie within the principle and scope of the disclosure, e.g., as expressed in the following claims.

Some embodiments can be embodied in the form of methods and apparatuses for practicing those methods. Some embodiments can also be embodied in the form of program code recorded in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing the patented invention(s). Some embodiments can also be embodied in the form of program code, for example, stored in a non-transitory machine-readable storage medium including being loaded into and/or executed by a machine, wherein, when the program code is loaded into and executed by a machine, such as a computer or a processor, the machine becomes an apparatus for practicing the patented invention(s). When implemented on a general-purpose processor, the program code segments combine with the processor to provide a unique device that operates analogously to specific logic circuits.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Unless otherwise specified herein, in addition to its plain meaning, the conjunction “if” may also or alternatively be construed to mean “when” or “upon” or “in response to determining” or “in response to detecting,” which construal may depend on the corresponding specific context. For example, the phrase “if it is determined” or “if [a stated condition] is detected” may be construed to mean “upon determining” or “in response to determining” or “upon detecting [the stated condition or event]” or “in response to detecting [the stated condition or event].”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure. For example, a relatively thin layer of adhesive or other suitable binder can be used to implement such “direct attachment” of the two corresponding components in such physical structure.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The description and drawings merely illustrate the principles of the disclosure. It will thus be appreciated that those of ordinary skill in the art will be able to devise various arrangements that, although not explicitly described or shown herein, embody the principles of the disclosure and are included within its scope. Furthermore, all examples recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions. Moreover, all statements herein reciting principles, aspects, and embodiments of the disclosure, as well as specific examples thereof, are intended to encompass equivalents thereof.

The functions of the various elements shown in the figures, including any functional blocks labeled as “processors” and/or “controllers,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

As used in this application, the term “circuitry” may refer to one or more or all of the following: (a) hardware-only circuit implementations (such as implementations in only analog and/or digital circuitry); (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

“SUMMARY OF SOME SPECIFIC EMBODIMENTS” in this specification is intended to introduce some example embodiments, with additional embodiments being described in “DETAILED DESCRIPTION” and/or in reference to one or more drawings. “SUMMARY OF SOME SPECIFIC EMBODIMENTS” is not intended to identify essential elements or features of the claimed subject matter, nor is it intended to limit the scope of the claimed subject matter.

1-32. (canceled)

33. An apparatus, comprising a wireless transceiver and a processor connected to the wireless transceiver to generate therefor a block-acknowledgement—BA—frame in response to a plurality of data units externally wirelessly transmitted to the wireless transceiver, the block-acknowledgement frame including a block-acknowledgement information field;
wherein the block-acknowledgement information field comprises:
a first bitmap having a sequence of one-bit flags, each one of the one-bit flags of the sequence corresponding to a respective one of sections of sequence numbers of the plurality of data units; and
a second bitmap having encoded therein an acknowledgement status of each data unit of the plurality of data units;
wherein, for a one-bit flag of the sequence having a first binary value, the second bitmap has a corresponding segment of bits representing acknowledgement statuses of the data units of the respective one of the sections; and
wherein, for a one-bit flag of the sequence having a second binary value, the second bitmap does not have a corresponding segment of bits.

34. The apparatus of claim 33, wherein, for the one-bit flag having the second binary value, all of the data units of the respective one of the sections have a same acknowledgement status.

35. The apparatus of claim 34, wherein the same acknowledgement status is “received” or is “not received.”

36. The apparatus of claim 33, wherein the second bitmap has a variable length.

37. The apparatus of claim 36, wherein the BA information field further comprises a first segment-control subfield having encoded therein a maximum length of the data units.

38. The apparatus of claim 33, wherein the BA information field comprises a control bit whose binary value determines interpretation of binary “0s” and “1s” of the second bitmap in terms of the acknowledgement status.

39. The apparatus of claim 33, wherein the apparatus is an access point.

40. The apparatus of claim 33, wherein the apparatus is a non-access-point station.

41. An apparatus, comprising a wireless transceiver and a processor connected to the wireless transceiver to determine acknowledgement statuses of a transmitted plurality of data units based on a received block-acknowledgement—BA—frame, which includes a block-acknowledgement information field;
wherein the block-acknowledgement information field comprises:
a first bitmap having a sequence of one-bit flags, each one of the one-bit flags of the sequence corresponding to a respective one of sections of sequence numbers of the plurality of data units; and
a second bitmap having encoded therein an acknowledgement status of each one of the plurality of data units;
wherein, for a one-bit flag of the sequence having a first binary value, the second bitmap has a corresponding segment of bits representing the acknowledgement statuses of the data units of the respective one of the sections; and
wherein, for a one-bit flag of the sequence having a second binary value, the second bitmap does not have a corresponding segment of bits.

42. The apparatus of claim 41, wherein, for the one-bit flag having the second binary value, all of the data units of the respective one of the sections have a same acknowledgement status.

43. The apparatus of claim 42, wherein the same acknowledgement status is “received” or is “not received.”.

44. The apparatus of claim 41, wherein the second bitmap has a variable length, and wherein the BA information field further comprises a first segment-control subfield having encoded therein a maximum length of the data units.

45. The apparatus of claim 41, wherein the BA information field comprises a control bit whose binary value is used for interpretation, by the processor, of binary “0s” and “1s” of the second bitmap in terms of the acknowledgement status.

46. The apparatus of claim 41, wherein the apparatus is an access point.

47. The apparatus of claim 41, wherein the apparatus is a non-access-point station.

48. A method, comprising generating a block-acknowledgement—BA—frame, said generating including:
generating a first bitmap having a sequence of one-bit flags, each one of the one-bit flags of the sequence corresponding to a respective one of sections of sequence numbers of a plurality of data units;
generating a second bitmap having encoded therein an acknowledgement status of each data unit of the plurality of data units; and
arranging the first and second bitmaps in an information field of the block-acknowledgement frame;
wherein, for a one-bit flag of the sequence having a first binary value, the second bitmap has a corresponding segment of bits representing acknowledgement statuses of the data units of the respective one of the sections; and
wherein, for a one-bit flag of the sequence having a second binary value, the second bitmap does not have a corresponding segment of bits.

49. The method of claim 48, wherein, for the one-bit flag having the second binary value, all of the data units of the respective one of the sections have a same acknowledgement status.

50. The method of claim 48, further comprising selecting a binary value for a control bit of the information field to indicate interpretation of binary “0s” and “1s” of the second bitmap in terms of the acknowledgement status.

51. The method of claim 48, further comprising transmitting the BA frame using a wireless transmitter.

52. A method, comprising decoding a received block-acknowledgement—BA—frame to determine acknowledgement statuses of a transmitted plurality of data units, said decoding including:
reading a first bitmap of an information field of the block-acknowledgement frame, the first bitmap having a sequence of one-bit flags, each one of the one-bit flags of the sequence corresponding to a respective one of sections of sequence numbers of the plurality of data units; and
decoding a second bitmap of the information field, the second bitmap having encoded therein an acknowledgement status of each one of the plurality of data units;
wherein, for a one-bit flag of the sequence having a first binary value, the second bitmap has a corresponding segment of bits representing the acknowledgement statuses of the data units of the respective one of the sections; and
wherein, for a one-bit flag of the sequence having a second binary value, the second bitmap does not have a corresponding segment of bits.

53. The method of claim 52, wherein, for the one-bit flag having the second binary value, all of the data units of the respective one of the sections have a same acknowledgement status.
